(19) United States
(12) Patent Application Publication
(10) Pub. No.: US 2018/0074841 A1
(43) Pub. Date: Mar. 15, 2018

(54) VLAN ARCHITECTURE WITH NETWORK NAMESPACE

(71) Applicant: THOMSON Licensing, Issy-les-Moulineaux (FR)

(72) Inventor: Simon RAVENHILL, Johns Creek, GA (US)

(21) Appl. No.: 15/705,600

(22) Filed: Sep. 15, 2017

Related U.S. Application Data
(60) Provisional application No. 62/394,785, filed on Sep. 15, 2016.

(51) Int. Cl. G06F 9/455; H04L 12/931; H04L 29/12; H04L 12/46; G06F 9/445

(52) U.S. Cl. CPC G06F 9/45558; H04L 49/354; H04L 61/6068; H04L 12/467; G06F 8/65; H04L 61/2038

(57) ABSTRACT

A method to separately address a plurality of network devices having the same IP address includes connecting a network switch having a plurality of ports to the plurality of network devices, each port representing a local area network connection to each one of the plurality of network devices, configuring the network switch to have a trunk port connection to a workstation, the trunk port configured to pass traffic for a plurality of virtual local area networks, each virtual area network assigned to a corresponding one of the plurality of network devices, configuring the workstation to assign a network namespace to each of the plurality of devices, creating a virtual interface for each of the plurality of network devices, and transmitting to each of the network devices individually using the unique name of each of the plurality of individual network devices.

### CROSS REFERENCE TO CORRESPONDING APPLICATIONS

This application claims priority benefit of U.S. Provisional Application Ser. No. 62/394,785 filed on 15 Sep. 2016, which is incorporated by reference herein in its entirety for all purposes.

### FIELD

The present invention relates to an architecture for parallel access to a plurality of IP networked devices in a test or configuration environment.

### BACKGROUND

At time of manufacture, customer premises equipment (CPE) devices are typically configured with identical network configuration settings including LAN-side settings, such as identical internal IP addresses. This poses a problem when the internal IP address is used to upgrade, test, or reconfigure the CPE device as it is difficult to scale any solution which can address more than a trivial number of devices in parallel. It is not possible to simply connect the LAN-side of more than one CPE device to an IP network and refer to them uniquely from a computer workstation as there will be IP address clashes because all the CPE devices have the same IP address. Thus, it becomes difficult and time consuming to perform a mass software upgrade, test, or reconfiguration of CPE (customer-premises equipment) of IP network devices in a factory or lab environment.

There are some known solutions to this problem, but they have disadvantages. One solution is to configure multiple physical computer workstations, one for each CPE network device undergoing software upgrade, tested or reconfiguration. The disadvantage of this approach is that the solution is expensive as one workstation and one operator is required for each CPE device to be upgraded, tested, or reconfigured in parallel. Alternately, CPE devices must be processed in a serial fashion which becomes time inefficient if the number of CPE devices becomes very large.

Another solution is to configure multiple virtual machines, one for each CPE network device undergoing software upgrade, test, or reconfiguration. The disadvantage of this approach being that the solution is complex to establish and maintain because one entire operating system needs to be installed and configured for each CPE device. Although this approach improves upon the above multiple computer workstation solution, the complexity of the solution and the non-trivial computer resource requirements of virtual machines means that the multiple virtual machine solution is difficult to scale up to accommodate a large number of CPEs.

Another possible solution is mechanical or software driven (IEEE 802.1Q VLAN configuration) network reconfiguration solution between the CPE devices and workstation. Although this approach allows for multiple CPE devices to be connected at one time, devices can only be processed one-by-one in a serial manner. This approach taxes personnel assigned to perform an update on a large quantify of CPE devices due to the labor and time of connecting and disconnecting CPE devices. Thus, this solution, by itself, is slow to process large quantities of CPE devices. An alternative approach is desirable.

### SUMMARY

This summary is provided to introduce a selection of concepts in a simplified form as a prelude to the more detailed description that is presented later. The summary is not intended to identify key or essential features of the invention, nor is it intended to delineate the scope of the claimed subject matter.

The novel disclosure combines key network isolation technologies in a unique way to enable the parallel software upgrade, test, and reconfiguration of non-unique CPE devices on a large scale. The novel disclosure addresses the clash of the identical LAN-side IP addresses possessed by each CPE device, by allowing multiple CPE devices to be referred to uniquely and in parallel from a single computer workstation. Once applied, the novel configuration allows for the parallel software upgrade, test, and reconfiguration of many CPE devices. This novel configuration greatly improves throughput of traditional CPE device processing in lab and factory environments.

Additional features and advantages of the invention will be made apparent from the following detailed description of illustrative embodiments which proceeds with reference to the accompanying figures. It should be understood that the drawings are for purposes of illustrating the concepts of the disclosure and is not necessarily the only possible configuration for illustrating the disclosure.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention. In the drawings, like numbers represent similar elements.

FIG. 1 illustrates an example environment suitable for performing a method of individually addressing multiple network devices having the same IP address;

FIG. 2 illustrates an example flow diagram for an embodiment using the capabilities of FIG. 1; and

FIG. 3 illustrates an apparatus block diagram having aspects of the disclosure.

### DETAILED DISCUSSION OF THE EMBODIMENTS

In the following description of various illustrative embodiments, reference is made to the accompanying drawings, which form a part thereof, and in which is shown, by way of illustration, how various embodiments in the invention may be practiced. It is to be understood that other embodiments may be utilized and structural and functional modification may be made without departing from the scope of the present invention.

Aspects of the novel configuration include the combination of IEEE 802.1Q VLAN tagging with Linux Network Namespace management to isolate CPE LAN-side networking. This combination allows a single computer workstation to manage and address multiple, identically configured CPE devices at one time (in parallel). Once applied, each CPE device is referred to by an arbitrary name rather than IP address allowing a single software process (test utility, software upgrade, or reconfiguration script) running on an appropriately configured Linux computer workstation to refer to each CPE device uniquely and in parallel.

The novel configuration improves the capability of a computer system to individually address CPE devices, such as modems or gateways, that have the same IP address for functions such as a mass parallel software upgrade, test, or reconfiguration of the CPE devices. Such a parallel access operation of a plurality of CPE devices having the same IP address cannot be performed by a human even when he/she uses standard computing equipment as a practical tool.

The current novel configuration improves a computer system to allow parallel access to a plurality of CPE devices having the same IP address. Thus, the current novel configuration and method is far beyond a mere abstract idea. Instead, the disclosure herein defines a realized novel improvement of a computer system to expand normal computer system capabilities to allow parallel access to a plurality of CPE devices having the same IP address. This is accomplished in the novel manner described herein below. In one embodiment, the disclosed configuration is useful to save time and costs in reconfiguring a plurality of CPE devices. In practice, time and cost savings has been observed in the test or reconfiguration of 10 or more CPE devices that have the same IP address using aspects of the disclosed configuration. Simultaneous access of any more than 10 CPE devices using conventional methods becomes non-trivial and cost prohibitive. In the implementation disclosed herein, up to 4096 CPE devices can be addressed simultaneously resulting in a dramatic improvement in test and/or reconfiguration capability compared to conventional methods that do not allow a substantial number of simultaneous or parallel access to such a plurality of CPE devices.

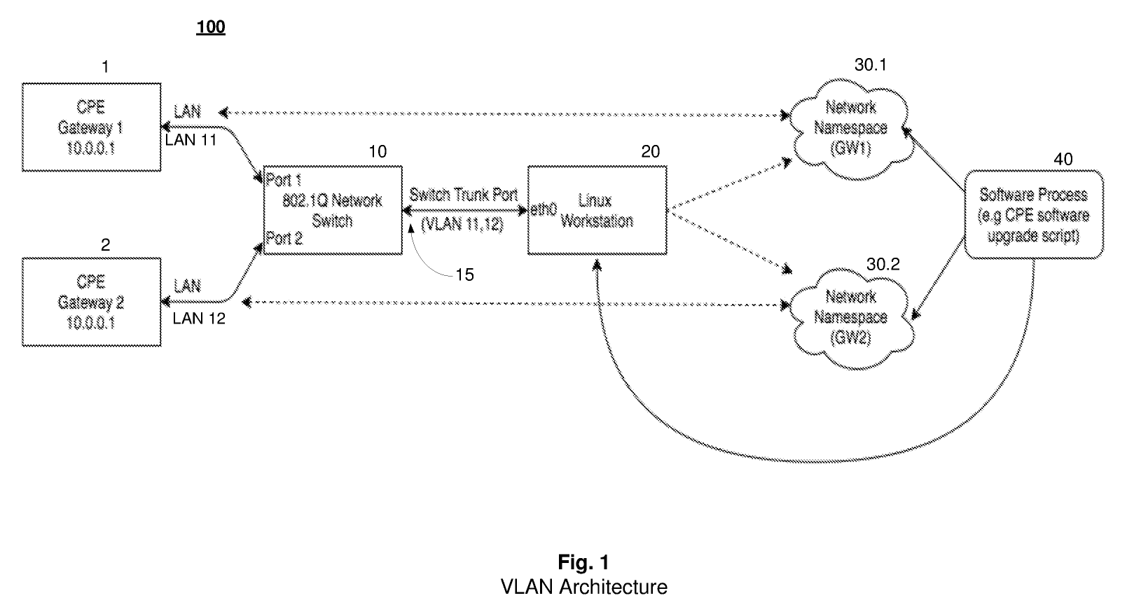

FIG. 1 depicts one possible embodiment of an architecture 100 in which the novel combination of VLAN architecture and Networking Namespace may be practiced. CPE Gateway 1 and CPE Gateway 2 represent physical broadband gateway devices to be configured, tested or upgraded. Although gateways are depicted and referenced, it is understood that other network devices, such as moderns may also be addressed with the disclosed configuration. CPE Gateway 1 is connected to network switch 10 using LAN 11 connected to port 1 of network switch 10. CPE gateway 2 is connected to LAN 12 connected to port 2 of network switch 10. It is understood that additional CPE devices, such as CPE Gateway n, not shown, would connect to a port n, not shown, of network switch n via a LAN XY, not shown, as needed. Thus, the architecture 100 is expandable and scales upward as needed to configure a multiple of CPE devices. FIG. 1 explicitly depicts only two gateway devices (CPE Gateway 1 and 2) however the number is limited only by the number of physical network ports available on the network switch 10. Thus, if network switch 10 had 64 ports, then 64 CPE devices would connect to network switch 10, each having a separate LAN connection. Thus, each CPE Gateway has its own LAN addressing each CPE gateway separately. Note that all gateways (CPE Gateway 1, and 2 through Gateway n) are assumed to have the same IP address, for example, 10.0.0.1, which would cause an address conflict in a network not VLAN isolation.

Network switch 10 is an IEEE 802.1Q or equivalent compatible network switch which is a virtual LAN (VLAN) capable network switch configured to isolate traffic from each network switch 10 access port into a separate VLAN. In FIG. 1, CPE Gateway 1 is connected to switch port 1 and assigned to VLAN 11. Similarly, CPE Gateway 2 is connected to switch port 2 and assigned to VLAN 12. If expanded, as in one embodiment, multiple CPE Gateways, up to CPE Gateway n can be connected to switch port n and assigned to respective VLANs, such as VLAN XY where XY is a respective VLAN numbering representation. All network traffic from switch ports 1 and 2 through n, VLAN 11 and VLAN 12 through VLAN XY, is tagged and transmitted through trunk port 15 and delivered to the Linux Workstation 20 via an available network switch port configured in trunk mode. The example in FIG. 1 is port eth0 of Linux workstation 20. Network traffic coming from the Linux Workstation is tagged as being destined for either CPE Gateway 1, CPE Gateway 2, or any specific CPE Gateway up to connected CPE Gateway n by using tags VLAN 11, VLAN 12, or VLAN XY as appropriate and delivered in untagged form to the corresponding CPE Gateway by the network switch 10.

Linux Workstation 20 represents a Linux PC workstation which supports network VLANs. The PC 20 has installed a version of the Linux Kernel equal to or newer than Linux Kernel Version 2.6.24 and thus supporting Network Namespaces. The use of Network Namespaces changes the fundamental idea that an installation of Linux shams a single set of network interfaces and routing table entries across the entire OS. With network namespaces, different and separate instances of network interfaces and routing tables can operate independent of each other. In the configuration of FIG. 1 the Linux workstation 20 is configured to create network namespaces, the purpose of which serves to isolate network traffic destined for and coming from each of the CPE Gateway devices; specifically GW1 for CPE Gateway 1, and GW2 for CPE Gateway 2, and so on until GWn for CPE Gateway n.

Within each network namespace (such as in example GW1, GW2, GWn) a virtual network interface is created and associated with a VLAN corresponding to the appropriate gateway. This causes the Linux Kernel to un-tag Ethernet frames previously encapsulated in VLAN tags, restoring them to untagged Ethernet frames. In this example, a virtual network interface is created within network namespace GW1 and associated with VLAN 11. Similarly, in network namespace GW2, a virtual network interface is created and associated with VLAN 12. As needed, in network namespace GWn, a virtual network interface is created and associated with VLAN XY.

Within each network namespace, the virtual network interface is assigned an IP address in the same subnet as the CPE Gateway either as a consequence of a Dynamic Host Configuration Protocol (DHCP) lease or statically if the gateway does not support DHCP, e.g. 10.0.0.50.

With this configuration, it is possible for a script or process, hosted on the Linux Workstation PC 20, which is aware of network namespaces, to transparently communicate with either CPE Gateway 1, 2, up to CPE Gateway n in parallel. The script or process can be intended to configure, test, or upgrade any of the CPE Gateways. To communicate with a particular gateway, the process refers to the CPE Gateway IP address in combination with the appropriate network namespace name. For example, the process for a particular CPE Gateway would refer to IP address 10.0.0.1 (assumed the same for all Gateways) and the specific namespace assigned to the Specific Gateway, such as GW1, GW2 up to GWn.

Also shown in FIG. 1 are network namespaces 30.1 and 30.2 for namespace GW1 and GW2 respectively that can occur within the workstation 20. Likewise, a network namespace can exist for more CPE gateways up to GWn. Namespace 30.1 corresponds to namespace GW1 on VLAN 11 corresponding to a virtually addressable space (virtual interface) for CPE gateway 1. Likewise, Namespace 30.2 corresponds to namespace GW1 on VLAN 12 corresponding to a virtually addressable space (virtual interface) for CPE gateway 2. Similarly, Network namespaces can be expanded to GWn to correspond to a virtual addressable space for CPE Gateway n. The namespaces 30.1 and 30.2 are depictions of areas of addressable and programmable areas useful for targeting threads of program code formed in the Linux workstation 20. The network namespace communication targets shown in dotted lines in FIG. 1. A software process 40 in FIG. 1 represents a script or other software targeted to the individual CPE Gateways by using the network namespace name (i.e. GW1, Gw2, GWn). Such a script is resident for execution in the Linux workstation 20.

Using the configuration of FIG. 1, a multitude of CPE Gateways having the same IP address can be accessed individually in parallel using a single PC workstation. Thus, saving time and computer resources. This configuration improves the capability of a computer system to address a plurality of CPE devices having the same IP address in a simultaneous or parallel access manner. As such the described configuration improves and expands upon the functionality of the individual elements of the system 100. As mentioned above, the disclosed novel configuration is advantageous when the number of network devices having the same IP address, such as CPE devices, is a large number, such as 10 network devices or more. Dealing with any more than that using conventional methods becomes non-trivial and cost prohibitive. The disclosed configuration supports up to 4094 simultaneous device accesses.

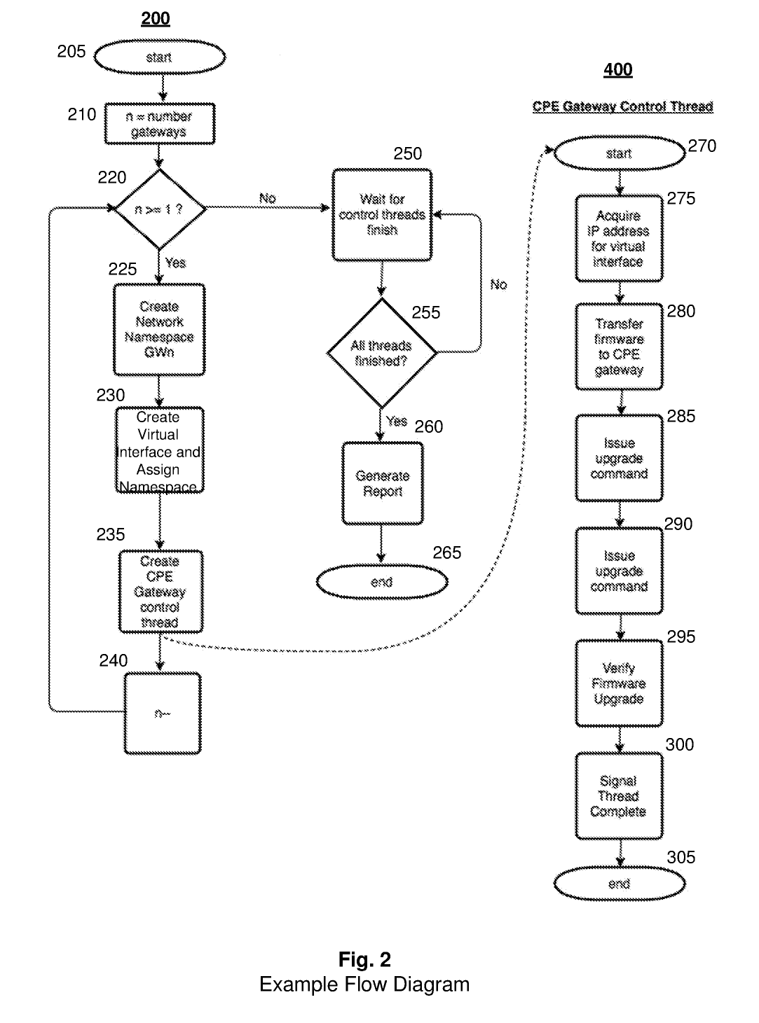

FIG. 2 is a flow diagram of an example application of the configuration environment of FIG. 1. The process 200 of FIG. 2, which includes steps 205 through 265, allows the parallel software upgrading of a multitude of CPE devices having the same IP address using the principles of unique addressing using the combination of network namespace and VLANs. The process assumes connecting a network switch having a plurality of ports to the plurality of network devices as in FIG. 1. Here, a port comprises a local area network connection to a corresponding one of the plurality of network devices. Also, the network switch is configured to have a trunk port connection to an apparatus, such as a computer. The computer may be a personal computer, workstation, or an embedded special purpose test equipment. The trunk port is configured to pass traffic for a plurality of virtual local area networks. A separate virtual area network is assigned to each of the plurality of network devices to be separately addressed, (i.e. individually addressable). Process 200 starts at step 205 and progresses to step 210 where the number of gateway units is set at n devices. At step 220, the number n is checked. If the number of gateway devices is greater than or equal to 1, step 225 creates a network namespace for a CPE gateway device. In one embodiment, the first unit may have a namespace name of GWn, the last unit may have a namespace name of GW1. A network namespace may also be referred to as a network identifier. Any name can be used for the CPE devices as long as each namespace or identifier name is unique. At step 230 two actions occur. First, a virtual interface is created for the CPE gateway (network device) just named. A virtual interface is a combination of a physical network interface plus VLAN assignment and the IP address. Additionally, the virtual interface just created is assigned to a corresponding network namespace for the network device (CPE device). This assignment of a network namespace (network identifier) to the virtual interface for network device (CPE device) has the effect of establishing a conceptual encapsulation of the virtual interface by the network namespace by virtue of network namespace as is well known to those of skill in the art. This conceptual encapsulation is effective so that the IP address assigned to the virtual interface does not create IP routes which conflict with any other interfaces on the system 100 which might be in the same IP address subnet. Thus, at step 230, a respective unique virtual interface for a network device, such as a CPE device, is assigned to a respective network identifier for each of the plurality of network devices.

At step 235, a CPE Gateway control thread is created to execute for the named gateway using the corresponding virtual interface. At this point, the CPE gateway control thread is created or accessed via memory and executed. A control thread may be any one of a CPE device software or firmware update, a test procedure, or reconfiguration of a CPE device. Thus, at Step 235, the created control thread for the network device (CPE device) is transmitted to the network devices individually using the network identifier assigned unique virtual interface for each of the plurality of network devices.

At step 240 the process 200 continues by decrementing the number n and returning to step 220. If the number n is greater than or equal to 1, then more namespaces, virtual interfaces, and control threads are to be created using steps 225 through 240 as before. This process continues until all CPE gateways have namespaces (identifiers), virtual interfaces, and control threads. When step 220 finds that n is zero, then the process 200 moves to step 250 where the process 200 waits until all of the threads created and started are finished using the loop at the step 255. At step 255, if all threads are finished, then a report may be generated indicating the success, failure, or concerns of any and all CPE gateways that were updated. The process 200 ends at step 265.

Control thread creation is depicted as an example flow of process 400 which includes step 270 through 305. Many control thread examples are possible that include software or firmware updates, test methods, or reconfiguration scripts. The process 400 is merely one example to illustrate a control thread process. Process 400 starts at step 270 and at step 275, an IP address is acquired for the virtual interface. This virtual address includes the IP address of the CPE gateway devices (such as common IP address 10.0.0.1) and the unique namespace (identifier) name created at step 230 for the specific CPE gateway whose control thread is being executed. For the embodiment where an upgrade to CPE equipment is being used as an example application, step 280 transfers new firmware to the specifically addressed CPE gateway. At steps 285 and 290, upgrade commands are issued to install the new firmware in the CPE device. At step 295, the firmware installation is verified and at step 300, the control thread 400 signals a completion. This completion is essentially reported back to step steps 250 and 255 to indicate that this specific CPE device is finished running its control thread. The specific CPE device being one of the multitude of threads advantageously running in parallel using the configuration of FIG. 1. The control thread ends at step 305.

In one aspect of the configuration of FIG. 1, the method performed by a workstation to separately address a plurality of network devices having the same IP address includes connecting a network switch having a plurality of ports to the plurality of network devices, each port representing a local area network connection to each one of the plurality of network devices. A network switch is configured to have a trunk port connection to a workstation, the trunk port configured to pass traffic for a plurality of virtual local area networks, each virtual area network assigned to a corresponding one of the plurality of network devices. The workstation is configured to assign a network namespace to each of the plurality of devices, each namespace (identifier) having a unique name. Virtual interfaces are created for each of the plurality of network devices. This allows the transmission to each of the network devices individually using the unique name of each of the plurality of individual network devices. The result is the ability to separately address each of the plurality of network devices having the same IP address. The novel configuration described is an improvement of a computer system by adding the ability to address, in parallel, a plurality of network devices, where each network device has the same IP address.

In one aspect of the configuration of FIG. 1, the workstation 20 is an apparatus to separately address a plurality of network devices having the same IP address. The workstation has a network interface connecting to a trunk port of a network switch, the network switch having individual LAN ports, each LAN port connected to one of the plurality of network devices, each network device having the same IP address. The workstation includes a processor having a namespace configuration capability, the processor assigning a unique namespace to each one of the plurality of networked devices and addressing each of the plurality of network devices having the same IP address individually using the IP address and the unique namespace.

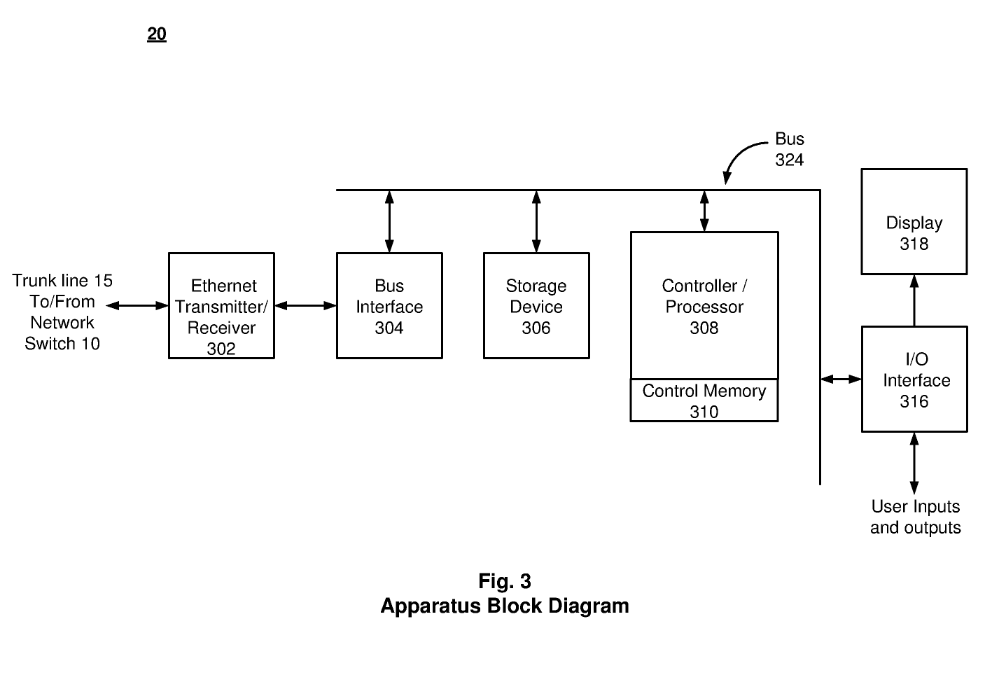

FIG. 3 is an example embodiment of an apparatus 20 to perform the method of FIG. 2. The apparatus of FIG. 3 can be either a special-purpose machine, part of a larger machine that performs other tasks, or an embedded special purpose machine. For example, the apparatus 20 of FIG. 3 can be a personal computer (PC) or a mainframe computer that is available for tasks such as testing, or an embedded computer in special purpose test equipment.

The apparatus 20 of FIG. 3 includes a transmitter/receiver interface 302 providing connectivity to the network interface switch 10 via trunk port 15. The trunk port 15 is configured to pass messages on a plurality of virtual local area networks (VLAN), each VLAN corresponding to a connection port of the network switch 10 associated with one of the plurality of network devices. The transmitter/receiver interface 302 connects to bus interface 304 which allows access to the internal bus 324. Multiple bus implementation options are also well known and within the scope of the overall architecture of apparatus 20. Other implementation, such as non-bus implementations are also possible as is well known to those of skill in the art. Present on bus 324 are a storage device 306 which can be used for any general storage such as retrieved or requested data and network management data, parameters, and programs. Storage device 306 may also serve as disk or solid-state storage such as RAM. Main program, utility, and other programs are under the control of controller/processor 308.

This controller/processor 308 may be a single processor or a multiplicity of processors performing the tasks of network switch 10 management, user interface control, and resource management. Controller/processor 308 or its multiprocessor equivalent can perform the method described in FIG. 2. Control memory 310 can supply program instruction and configuration control for controller/processor 308. Display 318 is one example of a user interface and allows a user, system owner, or system manager to view an operating condition of the apparatus 20.

An input/output (I/O) interface 316 complements the display 318 allowing the apparatus 20 to receive user inputs such as from a mouse, keyboard, light pen, and the like. I/O interface 316 may also allow connection to one or more data I/O interfaces for program input or data logging recording, for example. I/O interface 316 may also be used as an input mechanism used to configure and control the apparatus 20 functionality. The I/O interface 316 may include one or more of a hardline serial or parallel interfaces, RF or IR interfaces and the like to accommodate user input, display output, or other user interactive interfaces. I/O interface 316 may also include transmitters and receiver input and output interfaces for non-interactive user interfaces such as I/O for hard disk, optical, or solid-state recording and/or playback devices useful for program input and control and data collection management.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms. For example, implementation can be accomplished via a hardware apparatus, hardware and software apparatus. An apparatus may be implemented in, for example, appropriate hardware, software, and firmware. The methods may be implemented in, for example, an apparatus such as, for example, a processor, which refers to any processing device, including, for example, a computer, a microprocessor, an integrated circuit, or a programmable logic device.

Additionally, the methods may be implemented by instructions being performed by a processor, and such instructions may be stored on a processor or computer-readable media such as, for example, an integrated circuit, a software carrier or other storage device such as, for example, a hard disk, a compact diskette (“CD” or “DVD”), a random-access memory (“RAM”), a read-only memory (“ROM”) or any other magnetic, optical, or solid-state media. The instructions may form an application program tangibly embodied on a computer-readable medium such as any of the media listed above or known to those of skill in the art. The instructions thus stored are useful to execute elements of hardware and software to perform the steps of the method described herein.

1. A method to individually address a plurality of network devices, the method comprising:
connecting a network switch having a plurality of ports to a plurality of network devices, wherein a port comprises a local area network connection to a corresponding one of the plurality of network devices, the plurality of network devices having identical internet protocol addresses;
configuring the network switch to have a trunk port connection to a workstation, the trunk port configured to pass traffic for a plurality of virtual local area networks, a separate virtual area network assigned to each of the plurality of network devices to be separately addressed;
configuring the workstation to assign a unique network identifier to each of the plurality of network devices to be separately addressed;
creating a unique virtual interface for each of the plurality of network devices to be separately addressed;
assigning a respective unique virtual interface to a respective network identifier for each of the plurality of network devices;
transmitting to the network devices individually using the network identifier assigned unique virtual interface for each of the plurality of network devices.

2. The method of claim 1, wherein connecting a network switch comprises connecting an IEEE 802.1Q compatible switch to the plurality of network devices.

3. The method of claim 1, wherein configuring the workstation to assign a unique network identifier to each of the plurality of network devices to be separately addressed comprises configuring a workstation having namespace configuration capability to assign a unique namespace to each of the plurality of network devices.

4. The method of claim 1, wherein configuring the workstation to assign a unique network identifier to each of the plurality of network devices to be separately addressed comprises configuring a workstation to assign a unique name to each of the plurality of network devices.

5. The method of claim 1, wherein creating a unique virtual interface for each of the plurality of network devices to be separately addressed comprises creating a virtual interface using a combination of a respective physical network interface, virtual area network, and the IP address for a respective network device.

6. The method of claim 1, wherein transmitting to the network devices individually using the unique name of the plurality of individual network devices comprises transmitting a control thread to an addressed network device.

7. The method of claim 6, wherein the control thread comprises test, upgrade, or reconfiguration instructions.

8. An apparatus to separately address a plurality of network devices having identical internet protocol addresses, the apparatus comprising:
a network interface connecting to a trunk port of a network switch, the network switch having individual local area network ports, each local area network port connected to one of the plurality of network devices, each network device having a single internet protocol address;
a processor having a namespace configuration capability, the processor assigning a unique namespace and creating a unique virtual interface for each of the plurality of networked devices, the unique virtual interface address comprising a physical network address, a respective virtual local area network assignment, and the single internet protocol address, the processor assigning the unique virtual interface address to a respective unique namespace for a respective network device;
a transmitter and receiver interface driving the trunk port to communicate with the network switch using the namespace assigned unique virtual interface for each of the plurality of networked devices.

9. The apparatus of claim 8, wherein the trunk port is configured to pass messages on a plurality of virtual local area networks, each virtual local area network corresponding to a connection port associated with one of the plurality of network devices.

10. The apparatus of claim 8, wherein the network switch is a IEEE 802.1Q compatible network switch.

11. The apparatus of claim 8, wherein the processor namespace capability is a Linux network namespace program.

12. The apparatus of claim 8, wherein a quantity of the plurality of networked devices is 4096.

13. The apparatus of claim 8, wherein the transmitter and receiver interface drives the trunk port to communicate control instructions to the plurality of networked devices.

14. The apparatus of claim 13, wherein the instructions are one or more of a test program, a firmware update, and a reconfiguration of the plurality of networked devices.

15. The apparatus of claim 8, wherein the plurality of networked devices comprise either a gateway or a modem as customer premise devices.
